(19) United States
(12) Patent Application Publication
(10) Pub. No.: US 2026/0121557 A1
(43) Pub. Date: Apr. 30, 2026

(54) SYSTEMS AND METHODS FOR THERMAL ENERGY HARVESTING

(71) Applicant: Schlumberger Technology Corporation, Sugar Land, TX (US)

(72) Inventors: Tung Ngo, Sagamihara (JP); Linyuan Zhan, Singapore (SG); Cheng-Gang Xie, Singapore (SG)

(21) Appl. No.: 18/926,381

(22) Filed: Oct. 25, 2024

(51) Int. Cl. H02N 11/00; H02J 7/34

(52) U.S. Cl. CPC H02N 11/002; H02J 7/345; H02J 2207/50

(57) ABSTRACT

Systems and methods for thermal energy harvesting are provided. A thermal energy harvesting system includes: a power generation module including one or more thermal electric generation (TEG) modules, each of the TEG modules including at least one TEG unit configured to generate electrical energy converted from thermal energy that is output from a surface of a transport apparatus, a power storage module configured to store the electrical energy generated by the power generation module, and a power management module including a power conversion unit configured to convert the electrical energy stored in the power storage module to a power or voltage level for powering a payload configured for operating the transport apparatus.

### TECHNICAL FIELD

This disclosure generally relates to systems and methods for thermal energy harvesting.

### BACKGROUND

In geothermal power-generation applications, the process steam-water flow temperature is typically at 200° C. or higher. Therefore, the flow transport pipeline surface temperature is expected to be in the similar range and results in a large temperature difference between the pipeline surface and the ambient temperature.

### SUMMARY

This disclosure pertains to systems and methods for systems and methods for thermal energy harvesting.

A first aspect of this disclosure pertains to a thermal energy harvesting system, including: a power generation module including one or more thermal electric generation (TEG) modules, each of the TEG modules including at least one TEG unit configured to generate electrical energy converted from thermal energy that is output from a surface of a transport apparatus, a power storage module configured to store the electrical energy generated by the power generation module, and a power management module including a power conversion unit configured to convert the electrical energy stored in the power storage module to a power or voltage level for powering a payload configured for operating the transport apparatus.

A second aspect of this disclosure pertains to the system of the first aspect, wherein: the one or more TEG modules are provided in plurality, and the plurality of TEG modules are connected as one or more of: in series, in parallel, or in a combination of series and parallel connections.

A third aspect of this disclosure pertains to the system of the first aspect, wherein the power storage module includes one or more storage elements.

A fourth aspect of this disclosure pertains to the system of the third aspect, wherein the each of the one or more storage elements includes at least one of a rechargeable battery or a supercapacitor.

A fifth aspect of this disclosure pertains to the system of the third aspect, wherein the power storage module further includes an auxiliary circuit configured to manage power transfer between the power generation module and the one or more storage elements.

A sixth aspect of this disclosure pertains to the system of the fifth aspect, wherein the auxiliary circuit is operatively connected to the power generation module via a feedback signal line to adjust one or more connections for the one or more TEG modules to improve the conversion of thermal energy to electrical energy by the one or more TEG modules.

A seventh aspect of this disclosure pertains to the system of the sixth aspect, wherein the auxiliary circuit includes a maximum power point tracking (MPPT) mechanism configured to determine a maximum power output configuration for the TEG modules.

An eighth aspect of this disclosure pertains to the system of the first aspect, wherein the payload includes one or more of: geothermal fluid flow production measurement equipment, control equipment, a flow rate sensor, a velocity sensor, a phase fraction sensor, a composition sensor, a pressure sensor, a temperature sensor, a flow controller, an actuator, an electrically activated flow choke valve, a variable speed drive, a water injection pump, an artificial lift pump, an electric submersible pump, a water analysis sensor, an antenna, a microwave antenna, a differential pressure (DP) sensor, a processor, a processing system, a wired or wireless interface, or a memory.

A ninth aspect of this disclosure pertains to the system of the first aspect, and further includes: an alternative power source configured to provide electrical energy, and a switching mechanism configured to switch between: powering the payload from the power conversion unit, and powering the payload from the alternative power source.

A tenth aspect of this disclosure pertains to the system of the ninth aspect, wherein the alternative power source includes one or more of: an external power source, a grid power source, a battery power source, a generator, a portable power source, a capacitor power source, a turbine power source, a gas combustion turbine, a fluid driven turbine, a solar power source, or a wind power source.

An eleventh aspect of this disclosure pertains to a method, including: generating electrical energy converted by a thermal electric generation (TEG) unit from thermal energy that is output from a surface of a transport apparatus via a power generation module including one or more TEG modules, each of the TEG modules including at least one TEG unit, storing the electrical energy generated by the power generation module in a power storage module, and converting, by a power management module including a power conversion unit, the electrical energy stored in the power storage module to a power or voltage level for powering a payload configured for operating the transport apparatus.

A twelfth aspect of this disclosure pertains to the method of the eleventh aspect, wherein: the one or more TEG modules are provided in plurality, and the plurality of TEG modules are connected as one or more of: in series, in parallel, or in a combination of series and parallel connections.

A thirteenth aspect of this disclosure pertains to the method of the eleventh aspect, wherein the power storage module includes one or more storage elements.

A fourteenth aspect of this disclosure pertains to the method of the thirteenth aspect, wherein the each of the one or more storage elements includes at least one of a rechargeable battery or a supercapacitor.

A fifteenth aspect of this disclosure pertains to the method of the thirteenth aspect, wherein the power storage module further includes an auxiliary circuit managing power transfer between the power generation module and the one or more storage elements.

A sixteenth aspect of this disclosure pertains to the method of the fifteenth aspect, wherein the auxiliary circuit is operatively connected to the power generation module via a feedback signal line to adjust one or more connections for the one or more TEG modules to improve the conversion of thermal energy to electrical energy by the one or more TEG modules.

A seventeenth aspect of this disclosure pertains to the method of the sixteenth aspect, wherein the auxiliary circuit includes a maximum power point tracking (MPPT) mechanism determining a maximum power output configuration for the TEG modules.

An eighteenth aspect of this disclosure pertains to the method of the eleventh aspect, wherein the payload includes one or more of: geothermal fluid flow production measurement equipment, control equipment, a flow rate sensor, a velocity sensor, a phase fraction sensor, a composition sensor, a pressure sensor, a temperature sensor, a flow controller, an actuator, an electrically activated flow choke valve, a variable speed drive, a water injection pump, an artificial lift pump, an electric submersible pump, a water analysis sensor, an antenna, a microwave antenna, a differential pressure (DP) sensor, a processor, a processing system, a wired or wireless interface, or a memory.

A nineteenth aspect of this disclosure pertains to the method of the eleventh aspect, wherein: an alternative power source provides electrical energy, and a switching mechanism switches between: powering the payload from the power conversion unit, and powering the payload from the alternative power source.

A twentieth aspect of this disclosure pertains to the method of the nineteenth aspect, wherein the alternative power source includes one or more of: an external power source, a grid power source, a battery power source, a generator, a portable power source, a capacitor power source, a turbine power source, a gas combustion turbine, a fluid driven turbine, a solar power source, or a wind power source.

This summary is provided to introduce a selection of concepts that are further described below in the detailed description. This summary is not intended to identify key or essential features of the claimed subject matter, nor is it intended to be used as an aid in limiting the scope of the claimed subject matter.

Additional features and advantages of embodiments of the disclosure will be set forth in the description which follows, and in part will be obvious from the description, or may be learned by the practice of such embodiments. The features and advantages of such embodiments may be realized and obtained by means of the instruments and combinations particularly pointed out in the appended claims. These and other features will become more fully apparent from the following description and appended claims or may be learned by the practice of such embodiments as set forth hereinafter.

### BRIEF DESCRIPTION OF DRAWINGS

To describe the manner in which the above-recited and other features of the disclosure can be obtained, a more particular description will be rendered by reference to specific implementations thereof which are illustrated in the appended drawings. For better understanding, the like elements have been designated by like reference numbers throughout the various accompanying figures. While some of the drawings may be schematic or exaggerated representations of concepts, at least some of the drawings may be drawn to scale. Understanding that the drawings depict some example implementations, the implementations will be described and explained with additional specificity and detail through the use of the accompanying drawings in which:

FIG. 1 is a cross-sectional cutaway view of an example of a flow transport pipeline in accordance with an embodiment of the present disclosure.

FIG. 2 is a block diagram of a thermal energy harvesting system in accordance with an example embodiment of the present disclosure.

FIG. 3 is a power generation module in accordance with an example embodiment of the present disclosure.

FIG. 4 is a power generation module in accordance with an example embodiment of the present disclosure.

FIG. 5 is a power generation module in accordance with an example embodiment of the present disclosure.

FIG. 6 is a block diagram showing features of a power storage module in accordance with an example embodiment of the present disclosure.

FIG. 7 illustrates certain components that may be included within a computer system according to an example embodiment of the present disclosure.

Before any embodiments of the disclosure are explained in detail, it is to be understood that the disclosure is not limited in its application to the details of construction and the arrangement of components set forth in the following description or illustrated in the following drawings. The disclosure is capable of other embodiments and of being practiced or of being carried out in various ways. Example embodiments are illustrated in referenced figures of the drawings. It is intended that the embodiments and figures disclosed herein are to be considered illustrative rather than limiting. Also, it is to be understood that the phraseology and terminology used herein are for the purpose of description and should not be regarded as limiting. The use of “including,” “comprising,” or “having” and variations thereof are meant to encompass the items listed thereafter and equivalents thereof, as well as possible additional items. Unless specified or limited otherwise, the terms “mounted,” “connected,” “supported,” and “coupled” and variations thereof are used broadly and encompass both direct and indirect mountings, connections, supports, and couplings.

### DETAILED DESCRIPTION

While the subject disclosure applies to embodiments in many different forms, there are shown in the drawings and will be described in detail herein specific embodiments with the understanding that the present disclosure is an example of the principles of the disclosure. It is not intended to limit the disclosure to the specific illustrated embodiments. The features of the disclosure disclosed herein in the description, drawings, and claims can be significant, both individually and in any desired combinations, for the operation of the disclosure in its various embodiments. Features from one embodiment can be used in other embodiments. In the description of the drawings, like reference numerals refer to like elements.

In geothermal power-generation applications, the process steam-water flow through a flow transport pipeline has a high temperature relative to its surroundings. Consequently, the surface temperature of the flow transport pipeline will be higher than the surrounding rock or ground material, which means there is a significant difference between the pipeline's outer surface temperature and the ambient environment temperature, e.g., surrounding rock or ground or surrounding air.

The temperature difference provides a favorable condition for thermal energy harvesting. Meanwhile, measurement and/or control equipment may be installed on or near the pipeline may require electrical power input. The measurement and/or control equipment may include one or more of: a flow rate/velocity sensor, a phase fraction or composition sensor, a pressure sensor, a temperature sensor, a flow control valve, an actuator, a variable speed drive a variable speed drive for use with a water injection pump or a steam/water artificial lift pump, or the like. Embodiments of the present disclosure may include a thermal energy harvesting system to efficiently convert thermal to electrical energy to power the measurement and/or control equipment. The measurement equipment may use, for example, a differential pressure (DP) device to measure flow rate combined with a clamp-on gamma-ray phase fraction sensor, or a dual-DP measurement device, or an optical infrared phase fraction and velocity sensor. An electromagnetic RF/microwave transmission, reflection, resonance sensor system may be used as a phase fraction sensor, a water salinity sensor, and/or may be used as a flow velocity sensor, e.g., via cross-correlation transit-time or Doppler frequency-shift sensing method. The control equipment may be an actuator based on an electrically activated flow choke valve, or may be a variable speed drive to control a water injection pump, or to control an artificial lift, for example, an electric submersible, pump to boost the hot water/steam production in an enhanced geothermal system.

Example embodiments of the present disclosure may provide a compact system that provides electrical power by making use of the temperature difference between a surface of a transport apparatus, such as the surface of a pipeline, and the ambient environment. The system may include a power generation module, a power storage module, and a power management module. Because external power sources may be reduced or omitted, the system according to an example embodiment may be more compact that traditional power sources for pipeline operations. Example embodiments may also be more energy-efficient than traditional power sources for pipeline operations because they reclaim the naturally-produced thermal energy that traditional systems allow to be lost to the environment. Thus, example embodiments may be more cost-effective than traditional power sources for pipeline operations.

Example embodiments may reclaim the thermal energy that is typically lost to the ambient environment, for example, in a pipeline operation, e.g., a geothermal energy harvesting operation, and convert the reclaimed thermal energy to electrical power to provide power to the electrical equipment already being used in the pipeline operation. Such energy reclamation can reduce the costs and complexity of the pipeline operation because it is self-powering to the extent that the thermal energy conversion can provide sufficient power to the other pipeline operation equipment. As such, reliance on external power sources may be reduced or eliminated. In an example, external power sources may be needed only for initial setup of the operation, and then may be reused elsewhere while the thermal energy conversion provides sufficient power to maintain operation of the pipeline.

The power generation module may include a number of thermal electric generator (TEG) modules with different connection configurations that may operate based on Seebeck effect, heat conducting pads to the hot surface, and heat sinks to the ambient environment. The power storage module may be a set of rechargeable batteries, such as lithium-ion batteries or supercapacitors, and the auxiliary circuits to optimize the charging process. The power management module may convert and manage the stored energy to meet the operational requirements and reliability of a connected payload, such as a geothermal steam-water fluid flow production measurement and/or control equipment including one or more of: a flow rate/velocity sensor, a phase fraction or composition sensor, a pressure sensor, a temperature sensor, a flow control valve, an actuator, a variable speed drive for use with a water injection pump or a steam/water artificial lift pump, or the like.

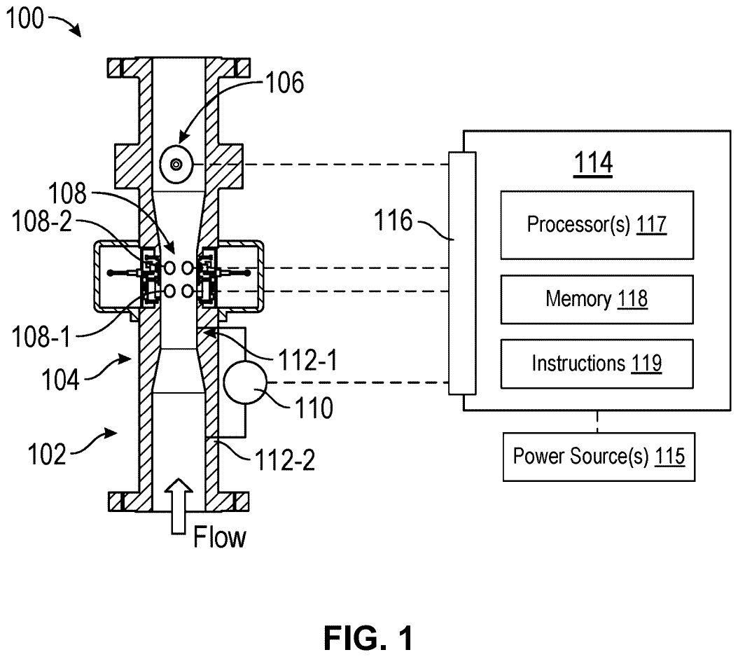

FIG. 1 is a cross-sectional cutaway view of an example of a flow transport pipeline in accordance with an embodiment of the present disclosure.

FIG. 1 shows an example of a flow transport pipeline 100 according to an embodiment. The pipeline 100 may include a conduit 102 having a flow restriction 104 (e.g., a Venturi), and a water analysis sensor 106 arranged in the conduit 102 and disposed downstream (e.g., in an outlet region after an end of the flow restriction), and at least a pair 108 of microwave antennas also arranged in the conduit 102. As shown in the example of FIG. 1, two pairs 108-1 and 108-2 of microwave antennas can be disposed in the throat of the flow restriction 104. The system 100 can also include a differential pressure (DP) sensor 110 for measuring a pressure difference between two locations 112-1 and 112-2, situated respectively upstream the flow restriction 104 and between opposing ends of the flow restriction 104 (e.g., at or proximate an inlet and in a throat of a Venturi).

As indicated by a large arrow, fluid can flow into the conduit 102. The fluid may be a multiphase fluid, which is a fluid that includes at least a liquid phase and a gas phase. It can include a liquid phase, for instance a water liquid phase - such as in a geothermal setup (with a gas phase being water vapor or steam) - or a plurality of liquid phases, for example, consider a water liquid phase and an oil liquid phase in a three-phase fluid that may be generally obtained when producing a hydrocarbon well.

As shown in the example of FIG. 1, the system 100 can also include a processing system 114 that can include one or more processors 117, operatively coupled to each of the sensors for acquiring data from the sensors and determining one or more parameters. As shown, the processing system 114 can include one or more interfaces 116, which can be wired and/or wireless interfaces that can operatively couple to sensors for acquisition of data and/or for control of one or more of the sensors. As an example, the processing system 114 can be operatively coupled to one or more power sources 115, which includes a thermal energy harvesting system in accordance with an embodiment of the present disclosure, and may further include a grid power source, a battery power source, a capacitor power source, a turbine power source (e.g., gas combustion turbine, fluid driven turbine, etc.), a solar power source, etc.

As an example, one or more sensors may be directly and/or indirectly coupled to one or more of the one or more power sources 115. As an example, the processing system 114 can include the one or more processors 117 (e.g., cores, etc.) and memory 118 that is processor-accessible. In such an example, the memory 118 can be a memory device that is a physical device that is non-transitory and not a carrier wave. In such an example, the memory device can be referred to as a processor-readable storage medium or a computer-readable storage medium. Such a memory device can store processor-executable instructions 119 (e.g., computer-executable instructions) that can be executed by the processing system 114 to cause the processing system 114 to perform various actions. For example, consider a method that includes various actions related to operation of the system 100 (e.g., one or more sensors, one or more antennas, etc.), determinations based on data generated by the system 100, etc.

In embodiments of the present disclosure, the power source 115 includes a thermal energy harvesting system that generates energy to provide power to any of the elements that are powered by the power source 115. The thermal energy harvesting system may fully replace or may augment an external power source, e.g., a grid power source, a battery power source, a capacitor power source, a turbine power source (e.g., gas combustion turbine, fluid driven turbine, etc.), a solar power source, etc.

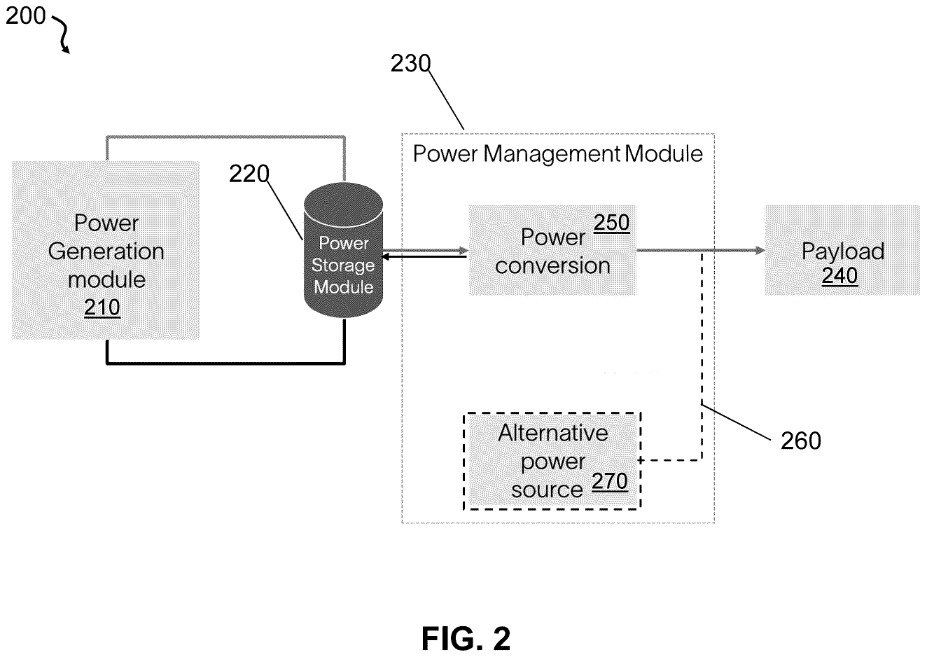

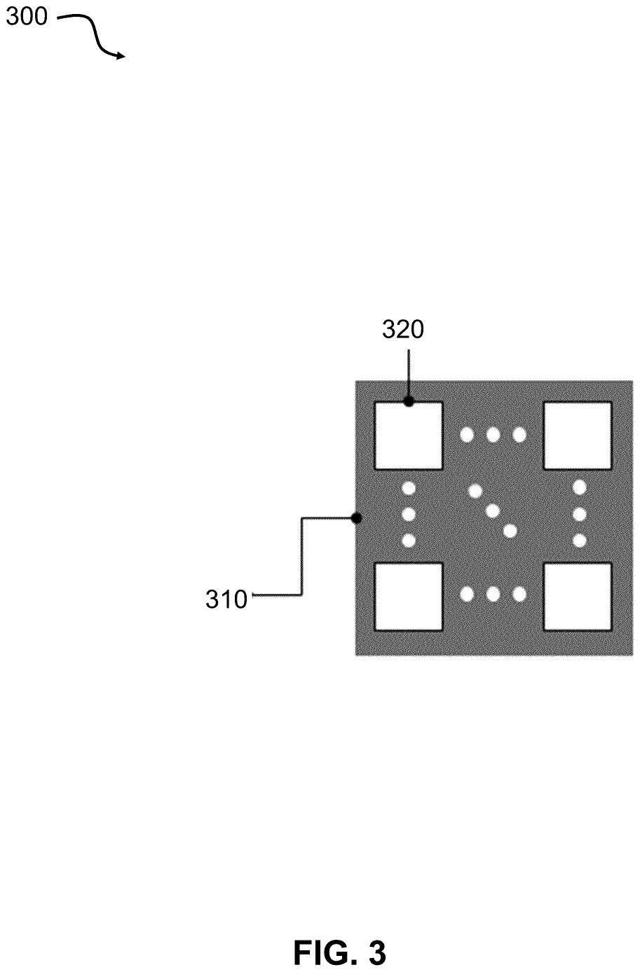

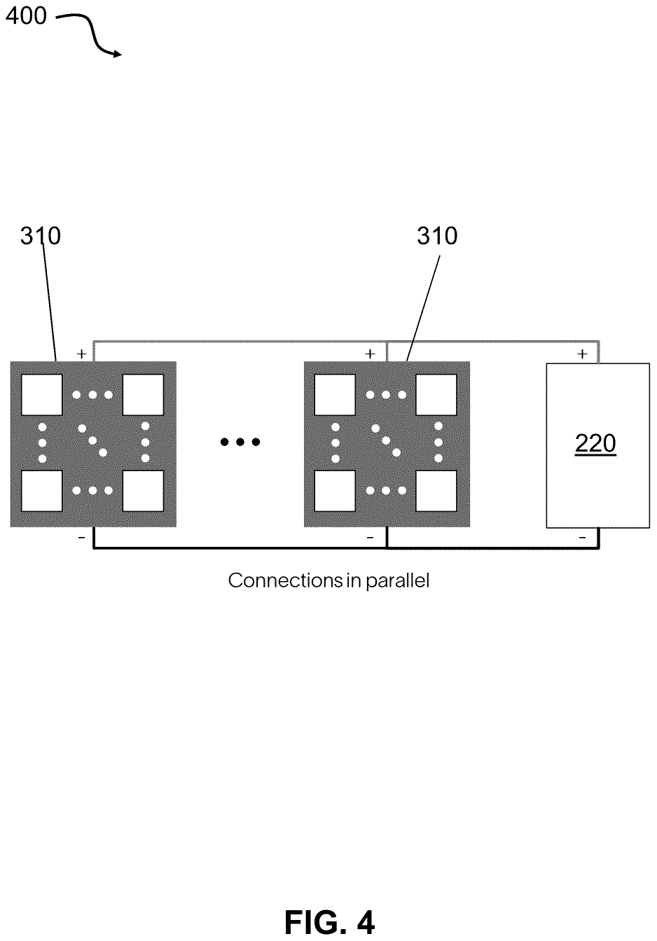

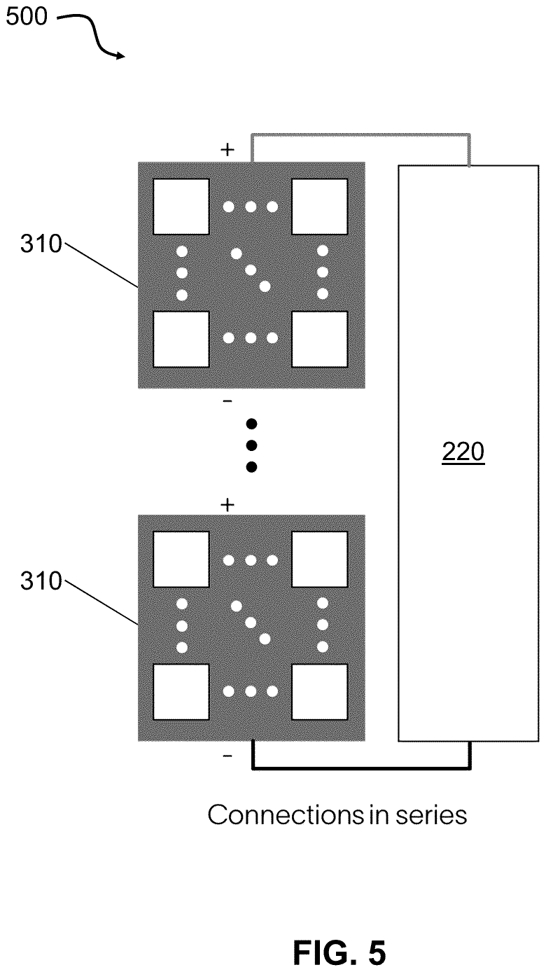

FIG. 2 is a block diagram of a thermal energy harvesting system in accordance with an example embodiment of the present disclosure. FIG. 3 is a power generation module in accordance with an example embodiment of the present disclosure. FIG. 4 is a power generation module in accordance with an example embodiment of the present disclosure. FIG. 5 is a power generation module in accordance with an example embodiment of the present disclosure.

A thermal energy harvesting system 200 in accordance with an example embodiment of the present disclosure may include a power generation module 210, a power storage module 220, and a power management module 230. The thermal energy harvesting system 200 may be used to provide power to a payload 240, e.g., any of the powered equipment shown in FIG. 1. The power generation module 230 may include one or more power conversion units 250. The power conversion unit 250 may convert energy stored in the power storage module 220 to desired and/or compatible power and voltage levels with the payload 240, e.g., a measurement and/or control equipment. The stored energy conversion may be configured to be efficient to avoid energy loss.

The power generation module 210 may include, for example, a thermal electric generation (TEG) module 310 for conversion from thermal energy to electric energy. In one example, the TEG units may operate based on, for example, the Seebeck effect, which is a phenomenon in which a temperature difference between two dissimilar electrical conductors or semiconductors produces a voltage difference between the two substances. Each TEG module 310 may include one or more TEG units 320. Multiple TEG modules 310 may be used, depending on the desired power output. The TEG modules 310 may be connected in series configuration as shown in FIG. 4, in parallel configuration as shown in FIG. 5, or a combination of both, to achieve the desired or optimal power conversion conditions. A chassis may ensure good thermal contact between the TEG modules 310 and the pipeline surface, while keeping the TEG modules 310 in place. A heat sink may effectively dissipate heat to the ambient environment to improve or maximize the temperature difference between the pipeline surface and the ambient environment. The heat sink may be part of or directly attached to the TEG module 310, the TEG unit 320, or may be attached to the chassis. The power generated by the TEG module(s) may be stored in the power storage module 220.

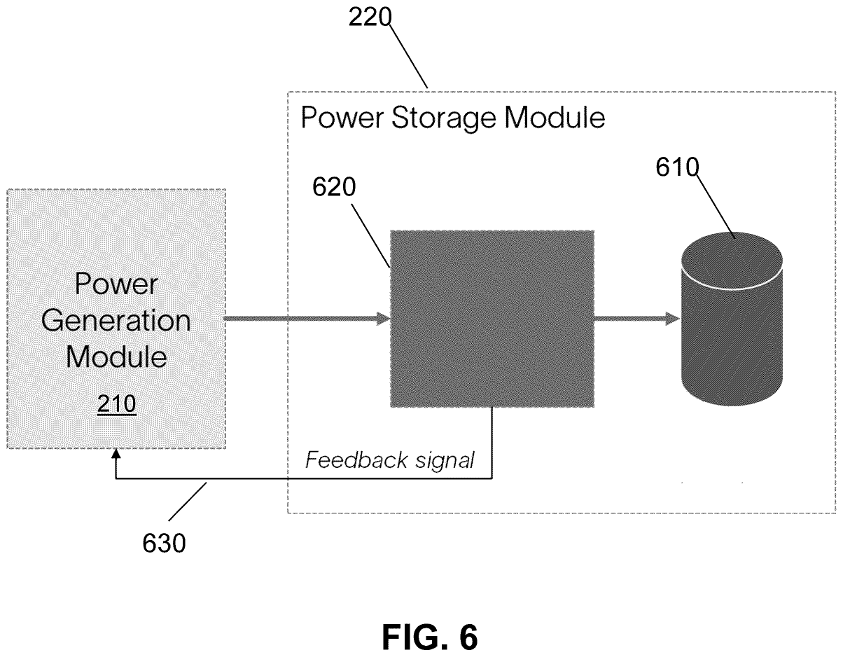

FIG. 6 is a block diagram showing features of a power storage module in accordance with an example embodiment of the present disclosure.

As shown in FIG. 6, the power storage module 220 may include one or more storage elements 610, for example, a rechargeable battery, e.g., a lead-acid battery, a lithium-ion (Li-ion) battery, a nickel-zinc (NiZn) battery, a lithium-ion polymer (LiPo) battery, a rechargeable alkaline battery, or a nickel-cadmium (NiCd) battery, or a supercapacitor, to store the electrical power, e.g., direct current (DC) power, harvested from the power generation module 210. The power storage module 220 may further include one or more auxiliary circuits 620 to manage and improve or optimize the power transfer process. The auxiliary circuit 620 may include a maximum power point tracking (MPPT) mechanism for adjusting the circuit configuration to achieve improved or optimal charging with less or minimum loss. The auxiliary circuit 620 may have a feedback signal line 630 to the power generation module 210 to adjust one or more connections in the power generation device 210, e.g., among the TEG modules 310, for improvement or optimization of the power conversion.

With reference again to FIG. 2, the power management module 230 may also optionally include a switching mechanism 260 for adaptively switching among different power sources, e.g., between the power generated from the power generation module 210 and an optional alternate power source 270. For example, the switching mechanism 260 may ensure stable operation of the payload, for example, the measurement and/or control equipment, e.g., if the payload 240 requires more power than is available from the power generation module 210 or power storage module 220. The switching mechanism 260 may be manual or automatic, e.g., to enable seamless power supply to the payload. The alternate power source 270 may include one or more of the above-discussed external power sources, e.g., a grid power source, a battery power source, a capacitor power source, a turbine power source (e.g., gas combustion turbine, fluid driven turbine, etc.), a solar power source, etc. As an example, a geothermal fluid flow production measurement and/or control equipment that may be the payload 240 may include one or more of: a flow rate/velocity sensor, a phase fraction or composition sensor, a pressure sensor, a temperature sensor, a flow controller, an actuator, or the like. The payload 240 may include control equipment such as, for instance, an actuator based on an electrically activated flow choke valve, or a variable speed drive to control a water injection pump, or to control an artificial lift (electric submersible) pump to boost the hot water/steam production in an enhanced geothermal system. In addition, the payload 240 may include any powered equipment described above with reference to FIG. 1.

Although a geothermal power-generation pipeline operation has been described as an example operation, example embodiments may be applied to any operation in which the surface temperature of a pipeline or other transport apparatus is sufficiently different from its ambient environment for a TEG module to function. For example, a brine mining operation may operate in an environment in which hot liquid passes through the pipeline.

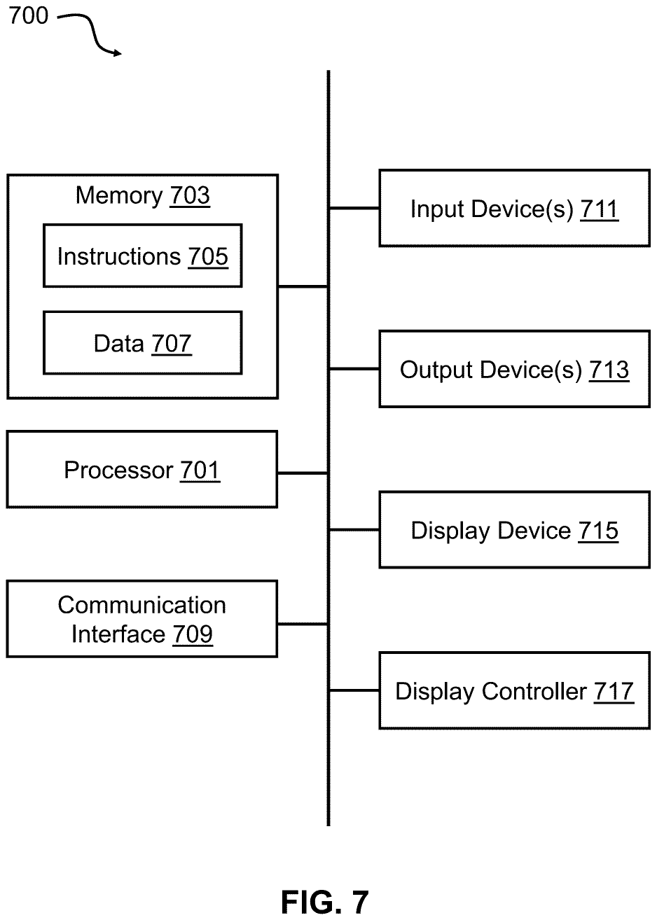

FIG. 7 illustrates certain components that may be included within a computer system according to an example embodiment of the present disclosure.

FIG. 7 illustrates certain components that may be included within a computer system 700, which may be used to control any thermal energy harvesting operation. One or more computer systems 700 may be used to implement the various devices, components, and systems described herein.

The computer system 700 includes a processor 701. The processor 701 may be a general-purpose single-or multi-chip microprocessor (e.g., an Advanced RISC (Reduced Instruction Set Computer) Machine (ARM)), a special-purpose microprocessor (e.g., a digital signal processor (DSP)), a microcontroller, a programmable gate array, etc. The processor 701 may be referred to as a central processing unit (CPU). Although just a single processor 701 is shown in the computer system 700 of FIG. 7, in an alternative configuration, a combination of processors (e.g., an ARM and DSP) could be used. In one or more embodiments, the computer system 700 further includes one or more graphics processing units (GPUs), which can provide processing services related to both entity classification and graph generation.

The computer system 700 also includes memory 703 in electronic communication with the processor 701. The memory 703 may be any electronic component capable of storing electronic information. For example, the memory 703 may be embodied as random access memory (RAM), read-only memory (ROM), magnetic disk storage media, optical storage media, flash memory devices in RAM, on-board memory included with the processor, erasable programmable read-only memory (EPROM), electrically erasable programmable read-only memory (EEPROM) memory, registers, and so forth, including combinations thereof.

Instructions 705 and data 707 may be stored in the memory 703. The instructions 705 may be executable by the processor 701 to implement some or all of the functionality disclosed herein. Executing the instructions 705 may involve the use of the data 707 that is stored in the memory 703. Any of the various examples of modules and components described herein may be implemented, partially or wholly, as instructions 705 stored in memory 703 and executed by the processor 701. Any of the various examples of data described herein may be among the data 707 that is stored in memory 703 and used during execution of the instructions 705 by the processor 701.

A computer system 700 may also include one or more communication interfaces 709 for communicating with other electronic devices. The communication interface(s) 709 may be based on wired communication technology, wireless communication technology, or both. Some examples of communication interfaces 709 include a Universal Serial Bus (USB), an Ethernet adapter, a wireless adapter that operates in accordance with an Institute of Electrical and Electronics Engineers (IEEE) 802.11 wireless communication protocol, a Bluetooth® wireless communication adapter, and an infrared (IR) communication port.

A computer system 700 may also include one or more input devices 711 and one or more output devices 713. Some examples of input devices 711 include a keyboard, mouse, microphone, remote control device, button, joystick, trackball, touchpad, and lightpen. Some examples of output devices 713 include a speaker and a printer. One specific type of output device that is typically included in a computer system 700 is a display device 715. Display devices 715 used with embodiments disclosed herein may utilize any suitable image projection technology, such as liquid crystal display (LCD), light-emitting diode (LED), gas plasma, electroluminescence, or the like. A display controller 717 may also be provided, for converting data 707 stored in the memory 703 into text, graphics, and/or moving images (as appropriate) shown on the display device 715.

The various components of the computer system 700 may be coupled together by one or more buses, which may include a power bus, a control signal bus, a status signal bus, a data bus, etc. For the sake of clarity, the various buses are illustrated in FIG. 7 as a bus system 719.

Following are sections in accordance with at least one embodiment of the present disclosure:

Clause 1: A thermal energy harvesting system, including: a power generation module including one or more thermal electric generation (TEG) modules, each of the TEG modules including at least one TEG unit configured to generate electrical energy converted from thermal energy that is output from a surface of a transport apparatus, a power storage module configured to store the electrical energy generated by the power generation module, and a power management module including a power conversion unit configured to convert the electrical energy stored in the power storage module to a power or voltage level for powering a payload configured for operating the transport apparatus.

Clause 2: The system of clause 1, wherein: the one or more TEG modules are provided in plurality, and the plurality of TEG modules are connected as one or more of: in series, in parallel, or in a combination of series and parallel connections.

Clause 3: The system of clause 1, wherein the power storage module includes one or more storage elements.

Clause 4: The system of clause 3, wherein the each of the one or more storage elements includes at least one of a rechargeable battery or a supercapacitor.

Clause 5: The system of clause 3, wherein the power storage module further includes an auxiliary circuit configured to manage power transfer between the power generation module and the one or more storage elements.

Clause 6: The system of clause 5, wherein the auxiliary circuit is operatively connected to the power generation module via a feedback signal line to adjust one or more connections for the one or more TEG modules to improve the conversion of thermal energy to electrical energy by the one or more TEG modules.

Clause 7: The system of clause 6, wherein the auxiliary circuit includes a maximum power point tracking (MPPT) mechanism configured to determine a maximum power output configuration for the TEG modules.

Clause 8: The system of clause 1, wherein the payload includes one or more of: geothermal fluid flow production measurement equipment, control equipment, a flow rate sensor, a velocity sensor, a phase fraction sensor, a composition sensor, a pressure sensor, a temperature sensor, a flow controller, an actuator, an electrically activated flow choke valve, a variable speed drive, a water injection pump, an artificial lift pump, an electric submersible pump, a water analysis sensor, an antenna, a microwave antenna, a differential pressure (DP) sensor, a processor, a processing system, a wired or wireless interface, or a memory.

Clause 9: The system of clause 1, further including: an alternative power source configured to provide electrical energy, and a switching mechanism configured to switch between: powering the payload from the power conversion unit, and powering the payload from the alternative power source.

Clause 10: The system of clause 9, wherein the alternative power source includes one or more of: an external power source, a grid power source, a battery power source, a generator, a portable power source, a capacitor power source, a turbine power source, a gas combustion turbine, a fluid driven turbine, a solar power source, or a wind power source.

Clause 11: A method, including: generating electrical energy converted by a thermal electric generation (TEG) unit from thermal energy that is output from a surface of a transport apparatus via a power generation module including one or more TEG modules, each of the TEG modules including at least one TEG unit, storing the electrical energy generated by the power generation module in a power storage module, and converting, by a power management module including a power conversion unit, the electrical energy stored in the power storage module to a power or voltage level for powering a payload configured for operating the transport apparatus.

Clause 12: The method of clause 11, wherein: the one or more TEG modules are provided in plurality, and the plurality of TEG modules are connected as one or more of: in series, in parallel, or in a combination of series and parallel connections.

Clause 13: The method of clause 11, wherein the power storage module includes one or more storage elements.

Clause 14: The method of clause 13, wherein the each of the one or more storage elements includes at least one of a rechargeable battery or a supercapacitor.

Clause 15: The method of clause 13, wherein the power storage module further includes an auxiliary circuit managing power transfer between the power generation module and the one or more storage elements.

Clause 16: The method of clause 15, wherein the auxiliary circuit is operatively connected to the power generation module via a feedback signal line to adjust one or more connections for the one or more TEG modules to improve the conversion of thermal energy to electrical energy by the one or more TEG modules.

Clause 17: The method of clause 16, wherein the auxiliary circuit includes a maximum power point tracking (MPPT) mechanism determining a maximum power output configuration for the TEG modules.

Clause 18: The method of clause 11, wherein the payload includes one or more of: geothermal fluid flow production measurement equipment, control equipment, a flow rate sensor, a velocity sensor, a phase fraction sensor, a composition sensor, a pressure sensor, a temperature sensor, a flow controller, an actuator, an electrically activated flow choke valve, a variable speed drive, a water injection pump, an artificial lift pump, an electric submersible pump, a water analysis sensor, an antenna, a microwave antenna, a differential pressure (DP) sensor, a processor, a processing system, a wired or wireless interface, or a memory.

Clause 19: The method of clause 11, wherein: an alternative power source provides electrical energy, and a switching mechanism switches between: powering the payload from the power conversion unit, and powering the payload from the alternative power source.

Clause 20: The method of clause 19, wherein the alternative power source includes one or more of: an external power source, a grid power source, a battery power source, a generator, a portable power source, a capacitor power source, a turbine power source, a gas combustion turbine, a fluid driven turbine, a solar power source, or a wind power source.

Systems and software, e.g., implemented on a non-transitory computer-readable medium, for performing the methods discussed herein are also within the scope of embodiments of the present disclosure.

Embodiments of the present disclosure may thus utilize a special purpose or general-purpose computing system including computer hardware, such as, for example, one or more processors and system memory. Embodiments within the scope of the present disclosure also include physical and other computer-readable media for carrying or storing computer-executable instructions and/or data structures, including applications, tables, data, libraries, or other modules used to execute particular functions or direct selection or execution of other modules. Such computer-readable media can be any available media that can be accessed by a general purpose or special purpose computer system. Computer-readable media that store computer-executable instructions (or software instructions) are physical storage media. Computer-readable media that carry computer-executable instructions are transmission media. Thus, by way of example, and not limitation, embodiments of the present disclosure can include at least two distinctly different kinds of computer-readable media, namely physical storage media or transmission media. Combinations of physical storage media and transmission media should also be included within the scope of computer-readable media.

Both physical storage media and transmission media may be used temporarily store or carry, software instructions in the form of computer readable program code that allows performance of embodiments of the present disclosure. Physical storage media may further be used to persistently or permanently store such software instructions. Examples of physical storage media include physical memory (e.g., RAM, ROM, EPROM, EEPROM, etc.), optical disk storage (e.g., CD, DVD, HDDVD, Blu-ray, etc.), storage devices (e.g., magnetic disk storage, tape storage, diskette, etc.), flash or other solid-state storage or memory, or any other non-transmission medium which can be used to store program code in the form of computer-executable instructions or data structures and which can be accessed by a general purpose or special purpose computer, whether such program code is stored as or in software, hardware, firmware, or combinations thereof.

A “network” or “communications network” may generally be defined as one or more data links that enable the transport of electronic data between computer systems and/or modules, engines, and/or other electronic devices. When information is transferred or provided over a communication network or another communications connection (either hardwired, wireless, or a combination of hardwired or wireless) to a computing device, the computing device properly views the connection as a transmission medium. Transmission media can include a communication network and/or data links, carrier waves, wireless signals, and the like, which can be used to carry desired program or template code means or instructions in the form of computer-executable instructions or data structures and which can be accessed by a general purpose or special purpose computer.

Further, upon reaching various computer system components, program code in the form of computer-executable instructions or data structures can be transferred automatically or manually from transmission media to physical storage media (or vice versa). For example, computer-executable instructions or data structures received over a network or data link can be buffered in memory (e.g., RAM) within a network interface module (NIC), and then eventually transferred to computer system RAM and/or to less volatile physical storage media at a computer system. Thus, it should be understood that physical storage media can be included in computer system components that also (or even primarily) utilize transmission media.

One or more specific embodiments of the present disclosure are described herein. These described embodiments are examples of the presently disclosed techniques. Additionally, in an effort to provide a concise description of these embodiments, not all features of an actual embodiment may be described in the specification. It should be appreciated that in the development of any such actual implementation, as in any engineering or design project, numerous embodiment-specific decisions will be made to achieve the developers'specific goals, such as compliance with system-related and business-related constraints, which may vary from one embodiment to another. Moreover, it should be appreciated that such a development effort might be complex and time consuming, but would nevertheless be a routine undertaking of design, fabrication, and manufacture for those of ordinary skill having the benefit of this disclosure.

The articles “a,” “an,” and “the” are intended to mean that there are one or more of the elements in the preceding descriptions. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features. For example, any element described in relation to an embodiment herein may be combinable with any element of any other embodiment described herein. Numbers, percentages, ratios, or other values stated herein are intended to include that value, and also other values that are “about” or “approximately” the stated value, as would be appreciated by one of ordinary skill in the art encompassed by embodiments of the present disclosure. A stated value should therefore be interpreted broadly enough to encompass values that are at least close enough to the stated value to perform a desired function or achieve a desired result. The stated values include at least the variation to be expected in a suitable manufacturing or production process, and may include values that are within 5%, within 1%, within 0.1%, or within 0.01% of a stated value.

A person having ordinary skill in the art should realize in view of the present disclosure that equivalent constructions do not depart from the spirit and scope of the present disclosure, and that various changes, substitutions, and alterations may be made to embodiments disclosed herein without departing from the spirit and scope of the present disclosure. Equivalent constructions, including functional “means-plus-function” clauses are intended to cover the structures described herein as performing the recited function, including both structural equivalents that operate in the same manner, and equivalent structures that provide the same function. It is the express intention of the applicant not to invoke means-plus-function or other functional claiming for any claim except for those in which the words ‘means for’ appear together with an associated function. Each addition, deletion, and modification to the embodiments that falls within the meaning and scope of the claims is to be embraced by the claims.

The terms “approximately,” “about,” and “substantially” as used herein represent an amount close to the stated amount that still performs a desired function or achieves a desired result. For example, the terms “approximately,” “about,” and “substantially” may refer to an amount that is within less than 5% of, within less than 1% of, within less than 0.1% of, and within less than 0.01% of a stated amount. Further, it should be understood that any directions or reference frames in the preceding description are merely relative directions or movements. For example, any references to “up” and “down” or “above” or “below” are merely descriptive of the relative position or movement of the related elements.

The present disclosure may be embodied in other specific forms without departing from its spirit or characteristics. The described embodiments are to be considered as illustrative and not restrictive. The scope of the disclosure is, therefore, indicated by the appended claims rather than by the foregoing description. Changes that come within the meaning and range of equivalency of the claims are to be embraced within their scope.

What is claimed is:

1. A thermal energy harvesting system, comprising:
a power generation module comprising one or more thermal electric generation (TEG) modules, each of the TEG modules comprising at least one TEG unit configured to generate electrical energy converted from thermal energy that is output from a surface of a transport apparatus;
a power storage module configured to store the electrical energy generated by the power generation module; and
a power management module comprising a power conversion unit configured to convert the electrical energy stored in the power storage module to a power or voltage level for powering a payload configured for operating the transport apparatus.

2. The system of claim 1, wherein:
the one or more TEG modules are provided in plurality; and
the plurality of TEG modules are connected as one or more of: in series, in parallel, or in a combination of series and parallel connections.

3. The system of claim 1, wherein the power storage module comprises one or more storage elements.

4. The system of claim 3, wherein the each of the one or more storage elements comprises at least one of a rechargeable battery or a supercapacitor.

5. The system of claim 3, wherein the power storage module further comprises an auxiliary circuit configured to manage power transfer between the power generation module and the one or more storage elements.

6. The system of claim 5, wherein the auxiliary circuit is operatively connected to the power generation module via a feedback signal line to adjust one or more connections for the one or more TEG modules to improve the conversion of thermal energy to electrical energy by the one or more TEG modules.

7. The system of claim 6, wherein the auxiliary circuit comprises a maximum power point tracking (MPPT) mechanism configured to determine a maximum power output configuration for the TEG modules.

8. The system of claim 1, wherein the payload comprises one or more of: geothermal fluid flow production measurement equipment, control equipment, a flow rate sensor, a velocity sensor, a phase fraction sensor, a composition sensor, a pressure sensor, a temperature sensor, a flow controller, an actuator, an electrically activated flow choke valve, a variable speed drive, a water injection pump, an artificial lift pump, an electric submersible pump, a water analysis sensor, an antenna, a microwave antenna, a differential pressure (DP) sensor, a processor, a processing system, a wired or wireless interface, or a memory.

9. The system of claim 1, further comprising:
an alternative power source configured to provide electrical energy; and
a switching mechanism configured to switch between:
powering the payload from the power conversion unit; and
powering the payload from the alternative power source.

10. The system of claim 9, wherein the alternative power source comprises one or more of:
an external power source, a grid power source, a battery power source, a generator, a portable power source, a capacitor power source, a turbine power source, a gas combustion turbine, a fluid driven turbine, a solar power source, or a wind power source.

11. A method, comprising:
generating electrical energy converted by a thermal electric generation (TEG) unit from thermal energy that is output from a surface of a transport apparatus via a power generation module comprising one or more TEG modules, each of the TEG modules comprising at least one TEG unit;
storing the electrical energy generated by the power generation module in a power storage module; and
converting, by a power management module comprising a power conversion unit, the electrical energy stored in the power storage module to a power or voltage level for powering a payload configured for operating the transport apparatus.

12. The method of claim 11, wherein:
the one or more TEG modules are provided in plurality; and
the plurality of TEG modules are connected as one or more of: in series, in parallel, or in a combination of series and parallel connections.

13. The method of claim 11, wherein the power storage module comprises one or more storage elements.

14. The method of claim 13, wherein the each of the one or more storage elements comprises at least one of a rechargeable battery or a supercapacitor.

15. The method of claim 13, wherein the power storage module further comprises an auxiliary circuit managing power transfer between the power generation module and the one or more storage elements.

16. The method of claim 15, wherein the auxiliary circuit is operatively connected to the power generation module via a feedback signal line to adjust one or more connections for the one or more TEG modules to improve the conversion of thermal energy to electrical energy by the one or more TEG modules.

17. The method of claim 16, wherein the auxiliary circuit comprises a maximum power point tracking (MPPT) mechanism determining a maximum power output configuration for the TEG modules.

18. The method of claim 11, wherein the payload comprises one or more of: geothermal fluid flow production measurement equipment, control equipment, a flow rate sensor, a velocity sensor, a phase fraction sensor, a composition sensor, a pressure sensor, a temperature sensor, a flow controller, an actuator, an electrically activated flow choke valve, a variable speed drive, a water injection pump, an artificial lift pump, an electric submersible pump, a water analysis sensor, an antenna, a microwave antenna, a differential pressure (DP) sensor, a processor, a processing system, a wired or wireless interface, or a memory.

19. The method of claim 11, wherein:
an alternative power source provides electrical energy; and
a switching mechanism switches between:
powering the payload from the power conversion unit; and
powering the payload from the alternative power source.

20. The method of claim 19, wherein the alternative power source comprises one or more of:
an external power source, a grid power source, a battery power source, a generator, a portable power source, a capacitor power source, a turbine power source, a gas combustion turbine, a fluid driven turbine, a solar power source, or a wind power source.
